(19) United States
(12) Patent Application Publication
(10) Pub. No.: US 2026/0071086 A1
(43) Pub. Date: Mar. 12, 2026

(54) INKJET INK

(71) Applicant: KYOCERA DOCUMENT SOLUTIONS INC., OSAKA (JP)

(72) Inventors: YUSUKE WASHINO, OSAKA (JP); KOTATSU KAWAGUCHI, OSAKA (JP); KATSUKI OSANISHI, OSAKA (JP); HIROKA ITANI, OSAKA (JP); KENTARO OKINAKA, OSAKA (JP); MOTOKI SUZUKI, OSAKA (JP); SHUN KANDA, OSAKA (JP)

(21) Appl. No.: 19/321,303

(22) Filed: Sep. 8, 2025

(30) Foreign Application Priority Data
Sep. 9, 2024 (JP) 2024-155035

(51) Int. Cl. C09D 11/38; C09D 11/324

(52) U.S. Cl. CPC C09D 11/38; C09D 11/324

(57) ABSTRACT

An inkjet ink includes: a pigment, a preservative, a zwitterionic compound, and water. The zwitterionic compound is a zwitterionic compound that has a zwitterionic structure in an environment with a pH of 7.5 or more and 9 or less. The preservative includes at least one of 2-(2-hydroxy-5-methylphenyl)benzotriazole, orthophenylphenol, sodium dihydroxydimethoxybenzophenonedisulfonate, para-aminobenzoic acid, ferulic acid, benzalkonium chloride, or the like. In the inkjet ink, the content of orthophenylphenol is 4 mass % or less and the content of ferulic acid is 7 mass % or less.

### CROSS-REFERENCE TO RELATED PATENT APPLICATION

This application claims the benefit of Japanese Priority Patent Application JP 2024-155035 filed Sep. 9, 2024, the entire contents of which are incorporated herein by reference.

### FIELD OF THE DISCLOSURE

The present disclosure relates to an inkjet ink.

### BACKGROUND OF THE DISCLOSURE

Some inkjet recording systems require workers such as users and maintenance workers to refill ink tanks with inks. Inks used in such systems are desired to be non-toxic to workers when they come into contact with the inks and be resistant to deterioration due to contamination with mold and growth thereof, etc. Further, such inks have the problem that the solvent is likely to evaporate due to exposure to the atmospheric air, during the work by the worker.

In inks containing pigments, the pigment tends to aggregate as the solvent evaporates, the dispersed state of the pigment in the solvent is difficult to maintain. In response to this, a technology that blends a moisturizing agent typified by glycerin and polyethylene glycol to make the ink less likely to dry has been widely known. Further, Japanese Patent Application Laid-open No. 2000-273376 discloses a technology that is capable of more effectively suppressing drying of the ink by blending a hygroscopic material to impart hygroscopicity to the ink.

### SUMMARY OF THE DISCLOSURE

According to an embodiment of the present disclosure, there is provided an inkjet ink, including: a pigment; a preservative; a zwitterionic compound; and water.

The zwitterionic compound is a zwitterionic compound that has a zwitterionic structure in an environment with a pH of 7.5 or more and 9 or less.

The preservative is at least one selected from the group consisting of 2-(2-hydroxy-5-methylphenyl)benzotriazole, orthophenylphenol, chlorcresol, sodium salicylate, sodium dihydroxydimethoxybenzophenonedisulfonate, sodium sorbate, thymol, trichlorohydroxydiphenyl ether, para-aminobenzoic acid, methyl para-hydroxybenzoate, para-chlorphenol, pyrithione zinc, piroctone olamine, phenylbenzimidazole sulfonic acid, phenol, ferulic acid, resorcin, cetylpyridinium chloride, benzalkonium chloride, and benzethonium chloride.

In the inkjet ink, a content of orthophenylphenol is 4 mass % or less, and a content of ferulic acid is 7 mass % or less.

### DETAILED DESCRIPTION OF THE EXEMPLARY EMBODIMENTS

In the ink in which a hygroscopic material is blended, the dispersion stability of the pigment in the solvent tends to be reduced due to the ionization of the ionic hygroscopic material to increase the amount of ions. Further, many ionic compounds are present in preservatives that have the effect of inhibiting the growth of mold and the like with which the preservatives are contaminated, and are highly safe. Therefore, even in the ink in which such a preservative is blended, the dispersion stability of the pigment in the solvent tends to be reduced.

In view of the circumstances as described above, it is an object of the present disclosure to provide an inkjet ink that is capable of suppressing the agglomeration of pigments in the solvent even with a configuration using an ionic preservative.

An embodiment of the present disclosure will be described.

### [Configuration of Ink]

### (Schematic Configuration)

An inkjet ink according to an embodiment of the present disclosure (hereinafter, also referred to simply as an “ink”) includes: a pigment a; a preservative b; an anti-drying agent c; and water. The ink according to this embodiment is a water-based ink that is ejected from a recording head of an inkjet recording apparatus onto a recording medium to record an image on the recording medium. Examples of the recording medium on which an image is recorded by the ink according to this embodiment include plain paper, copy paper, recycled paper, thin paper, thick paper, glossy paper, and OHP.

In the ink according to this embodiment, it is possible to effectively suppress the agglomeration of pigments by the effect of the anti-drying agent c even with a configuration using the ionic preservative b. Details of each component of the ink according to this embodiment will be described below.

### (Pigment a)

The ink according to this embodiment includes the pigment a as a coloring agent from the viewpoints of color mixing prevention and improvement in water resistance in images recorded on the recording medium. The pigment a may be an inorganic pigment or an organic pigment. Further, as the pigment a, these may be combined with an extender pigment as necessary.

Specific examples of the inorganic pigment that can be used in the ink according to this embodiment include carbon black and a metal oxide. In particular, in the case of a black ink, carbon black is favorable. Examples of the carbon black include furnace black, thermal lamp black, acetylene black, and channel black.

Specific examples of the organic pigment that can be used in the ink according to this embodiment include an azo pigment, a diazo pigment, a phthalocyanine pigment, a quinacridone pigment, an isoindolinone pigment, a dioxazine pigment, a perylene pigment, a perinone pigment, a thioindigo pigment, an anthraquinone pigment, and a quinophthalone pigment.

In the ink according to this embodiment, the hue is not particularly limited, and a colored pigment of any of colors such as yellow, magenta, cyan, blue, red, orange, and green can be used. Favorable specific examples of the colored pigment include C.I. Pigment Yellow, C.I. Pigment Red, C.I. Pigment Orange, C.I. Pigment Violet, C.I. Pigment Blue, and C.I. Pigment Green. The ink according to this embodiment can use one or two or more selected from these colored pigments as the pigment a.

### (Preservative b)

The preservative b blended in the ink according to this embodiment is a highly safe ionic compound that has the effect of inhibiting the growth of mold and the like and is non-toxic to workers when they come into contact with it. The preservative b is typically selected from those that ionize when dissolved in water, of the preservatives listed in “Standards for Cosmetics (Ministry of Health and Welfare Notification No. 331 of 2000)”.

Specifically, the preservative b is at least one of 2-(2-hydroxy-5-methylphenyl)benzotriazole, orthophenylphenol, chlorcresol, sodium salicylate, sodium dihydroxydimethoxybenzophenonedisulfonate, sodium sorbate, thymol, trichlorohydroxydiphenyl ether, para-aminobenzoic acid, methyl para-hydroxybenzoate, para-chlorphenol, pyrithione zinc, piroctone olamine, phenylbenzimidazole sulfonic acid, phenol, ferulic acid, resorcin, cetylpyridinium chloride, benzalkonium chloride, or benzethonium chloride.

In the ink according to this embodiment, with the configuration using at least one of 2-(2-hydroxy-5-methylphenyl)benzotriazole, orthophenylphenol, sodium dihydroxydimethoxybenzophenonedisulfonate, para-aminobenzoic acid, ferulic acid, or benzalkonium chloride as the preservative b, the maximum allowable addition amount is relatively large and a greater benefit due to the effect of suppressing the agglomeration of the pigment a in the solvent is obtained.

In the ink according to this embodiment, the content of the preservative b is favorably 1 mass % or more in order to sufficiently obtain the effect of the preservative b. Meanwhile, in the ink according to this embodiment, it is favorable that the preservative b is not blended in an amount exceeding the maximum blending amount specified in the above Standards for Cosmetics. Further, in the ink according to this embodiment, the content of the preservative b is 4 mass % or less when orthophenylphenol is used, and the content of the preservative b is 7 mass % or less when ferulic acid is used.

### (Anti-Drying Agent c)

The anti-drying agent c blended in the ink according to this embodiment has high moisturizing properties, thereby exerting the effect of preventing the solvent from evaporating. In the ink according to this embodiment, a zwitterionic compound that has a zwitterionic structure in an environment with a pH of 7.5 or more and 9 or less is used as the anti-drying agent c. The zwitterionic compound is a compound that has a cationic center and an anionic center in its molecule and is neutral overall.

The anti-drying agent c exerts the effect of suppressing the agglomeration of the pigment a in the solvent in addition to the effect of preventing the solvent from evaporating. That is, in the ink according to this embodiment, by blending a zwitterionic compound that is neutral overall, it is possible to increase the dielectric constant without affecting the electric double layer. As a result, in the ink according to this embodiment, the electrostatic repulsive force between the pigments a becomes stronger, thereby suppressing the agglomeration of the pigment a and making the dispersed state of the pigment in the solvent less likely to be impaired even with a configuration using the ionic preservative b. For this reason, in the ink according to this embodiment, high dispersion stability of the pigment a in the solvent is achieved and the dispersed state of the pigment a is easily maintained for a long period of time.

The zwitterionic compound constituting the anti-drying agent c blended in the ink according to this embodiment is favorably at least one of a betaine-type compound, a sulfobetaine-type compound, and an N,N,N-trialkyl N-oxy compound in order to more effectively suppress the agglomeration of the pigment a in the solvent. Further, from the same viewpoint, it is favorable that the anti-drying agent c does not include any of a linear alkane skeleton having four or more carbon atoms, a triethylene glycol skeleton having four or more carbon atoms, or a tripropylene glycol skeleton having four or more carbon atoms.

In the ink according to this embodiment, the content of the anti-drying agent c is 3 mass % or more in order to sufficiently obtain the above effect of suppressing the agglomeration of the pigment a. Further, in the ink according to this embodiment, the content of the anti-drying agent c is favorably 10 mass % or less from the viewpoint of preventing precipitation during drying.

### (Water)

In the ink according to this embodiment, ion exchanged water, purified water, distilled water, or the like can be used as water. In the ink according to this embodiment, the content of water is favorably 60 mass % or more and 70 mass % or less from the viewpoints of dryness and ejection reliability.

### (Other Components)

In the ink according to this embodiment, components other than the above may be blended as necessary. For example, a dispersant that has the effect of enhancing the dispersibility of the pigment a in the solvent may be blended in the ink according to this embodiment. As the dispersant, a pigment dispersion resin, a surfactant, or the like can be used.

The pigment dispersion resin is fine particles of a resin and is adsorbed on the surface of the pigment a to enhance the dispersibility of the pigment a in the solvent. The molecular weight of the pigment dispersion resin is favorably approximately several ten thousand. Examples of the pigment dispersion resin include an acrylic resin, a styrene-acrylic resin, a styrene-maleic acid resin, and a urethane resin. Of these, the styrene-acrylic resin is favorable. It is favorable that the pigment dispersion resin has an acid value of 150 mg KOH/g or more from the viewpoints of improving the dispersibility of the pigment a in the solvent, micronization, and improving the color development and coloration power of the pigment a. Meanwhile, the pigment dispersion resin favorably has an acid value of 300 mg KOH/g or less from the viewpoint of improving the preservation stability of the ink.

The surfactant blended as a dispersant reduces the interfacial tension between the pigment a and the solvent to enhance the dispersibility of the pigment a in the solvent. As such a surfactant, for example, a nonionic surfactant or an anionic surfactant can be used.

Further, in the ink according to this embodiment, various additives such as a deliquescent agent, a dissolution stabilizer, an antioxidant, a viscosity adjustor, a pH adjuster, and a neutralizer may be blended as necessary, in addition to the dispersant.

### Examples

Inks were prepared and evaluated as Examples of the present disclosure.

### (Preparation of Ink)

### Preparation of Pigment Dispersion Resin

An alkali-soluble resin that includes a repeating unit derived from methacrylic acid (MAA unit), a repeating unit derived from methyl methacrylate (MMA unit), a repeating unit derived from butyl acrylate (BA unit), and a repeating unit derived from styrene (ST unit) was prepared. 100 parts by mass of this alkali-soluble resin and an aqueous potassium hydroxide solution including 10.5 parts by mass of potassium hydroxide were mixed. In this way, the alkali-soluble resin was neutralized with an equal amount (strictly, 105% amount) of KOH. In this way, a pigment dispersion resin solution including the pigment dispersion resin and water was obtained.

### Preparation of Pigment Dispersion Liquid

The pigment a (“LIONOL (registered trademark) BLUE FG-7330” manufactured by Toyocolor Co., Ltd., component: copper phthalocyanine, color index: Pigment Blue 15:3), the above-mentioned pigment dispersion resin solution, “OLFINE (registered trademark) E1010” manufactured by Nissin Chemical Co., Ltd. (ethylene oxide adduct of acetylenediol) as a surfactant, and ion exchanged water were added to a vessel having a capacity of 0.6 L such that the composition shown in the following Table 1 was achieved. Subsequently, the content of the vessel was wet dispersed using a media-type wet disperser (“DYNO (registered trademark)-MILL” manufactured by Willy A Bachofen A G (WAB)).

TABLE 1

| Component | Content (mass %) |
|---|---|
| Water | 78.5 |
| Pigment dispersion resin | 6 |
| Pigment a | 15 |
| Surfactant | 0.5 |

Note that the content of “water” in Table 1 indicates the total content of the above-mentioned ion exchanged water added to the vessel and the water contained in the pigment dispersion resin solution (specifically, the water contained in the aqueous potassium hydroxide solution used to neutralize the alkali-soluble resin and the water generated during the neutralization reaction of potassium hydroxide).

Subsequently, the above-mentioned content of the vessel was dispersed using zirconia beads as media (particle diameter of 0.5 mm) and a wet disperser (“Nano Grain Mill” manufactured by ASADA IRON WORKS.CO., LTD.). The dispersion conditions were a temperature of 10° C. and a circumferential speed of 8 m/sec. In this way, a pigment dispersion liquid was obtained.

### Preparation of Resin Emulsion

A stirrer, a nitrogen introduction tube, a capacitor, a stirrer, and a dropping funnel were set for a four-necked flask (capacity of 1000 mL). This was used as a reaction vessel. Next, 100 g of isopropyl alcohol and 300 g of methyl ethyl ketone were added to the reaction vessel. Next, the content of the reaction vessel was heated to reflux at 70° C. while bubbling nitrogen. Separately, 50.0 g of butyl acrylate (BA), 10.0 g of lauryl acrylate (LA), 25.0 g of methyl methacrylate (MMA), 15.0 g of 2-ethylhexyl acrylate (2EHA), and 0.400 g of azobisisobutyronitrile (AIBN, a polymerization initiator) were mixed to obtain a monomer solution. The content of the reaction vessel was heated to reflux at 70° C. and the monomer solution was added dropwise to the reaction vessel over approximately 2 hours. After the adding dropwise, the content of the reaction vessel was further heated to reflux at 70° C. for 6 hours. Subsequently, a solution including 0.200 g of AIBN and 50 g of methyl ethyl ketone was added dropwise to the reaction vessel over 15 minutes. After the adding dropwise, the content of the reaction vessel was further heated to reflux at 70° C. for 5 hours. In this way, a resin solution including a resin X was obtained. Subsequently, the obtained resin solution was heated to 70° C. under reduced pressure to evaporate the solvent (methyl ethyl ketone and isopropyl alcohol), thereby obtaining the dried resin X.

45 g of water and 50 g of the resin X were added to a flask and then heated at 70° C. After that, it was allowed to stand for 15 minutes. In this way, the resin X was harmonized in water. Subsequently, 5 g of a nonionic surfactant (“EMULGEN (registered trademark) 1153S-70” manufactured by Kao Corporation, a polyoxyethylene alkyl ether) was added to the above-mentioned flask and stirred slowly. The dispersion liquid obtained by stirring was processed (600 MPa, 3 passes) by a high-pressure homogenizer (“Panda PLUS 2000” manufactured by GEA Niro Soavi). In this way, a resin emulsion was obtained.

### Preparation of Ink

Ion exchanged water, the preservative b, the anti-drying agent c, and trimethylolpropane (manufactured by Tokyo Chemical Industry Co., Ltd.) were added to a flask equipped with a stirrer (“Three-One Motor (registered trademark) BL-600” manufactured by Shinto Scientific Co., Ltd.). A 50% aqueous sodium hydroxide solution (manufactured by Tokyo Chemical Industry Co., Ltd) was added dropwise while stirring (stirring speed: 400 rpm) the content using the above-mentioned stirrer to adjust the pH to 7.6 to 8.0. Further, ion exchanged water was added to obtain a specified formulation ratio, and the above-mentioned pigment dispersion liquid and resin emulsion were added in this order. The ratio of the addition amount of each raw material was as shown in the following Table 2. The mixed solution was filtered using a syringe filter having a pore size of 5 μm in order to remove foreign substances and coarse particles from the obtained mixed solution, thereby obtaining an ink. For each ink, the type and content of the preservative b were changed. Preservatives b1 to b20 used in Examples are shown in Table 3. Further, Table 3 also shows the maximum blending amount of each of the preservatives b1 to b20.

TABLE 2

| Component | Content (mass %) |
|---|---|
| Pigment dispersion liquid | 40 |
| Resin emulsion | 3 |
| Trimethylolpropane | 10 |
| Preservative | Determine for each sample |
| Anti-drying agent c | 12 |
| Water | Remainder |

TABLE 3

| | | Maximum | |
|---|---|---|---|
| | | blending | |
| | | amount | |
| Preservative | Name | (mass %) | Manufacturer |
| b1 | 2-(2-hydroxy-5-methylphenyl) | 7 | Sigma-Aldrich Co. LLC |
| | benzotriazole | | |
| b2 | Orthophenylphenol | — | Tokyo Chemical Industry Co., Ltd. |
| b3 | Chlorcresol | 0.5 | Tokyo Chemical Industry Co., Ltd. |
| b4 | Sodium salicylate | 1 | FUJIFILM Wako Pure Chemical Corporation |
| b5 | Sodium | 10 | FUJIFILM Wako Pure Chemical Corporation |
| | dihydroxydimethoxybenzophenonedisulfonate | | |
| b6 | Sodium sorbate | 0.5 | Tokyo Chemical Industry Co., Ltd. |
| b7 | Thymol | 0.05 | Tokyo Chemical Industry Co., Ltd. |
| b8 | Trichlorohydroxydiphenyl ether | 0.1 | Tokyo Chemical Industry Co., Ltd. |
| b9 | Para-aminobenzoic acid | 4 | FUJIFILM Wako Pure Chemical Corporation |
| b10 | Methyl para-hydroxybenzoate | 1 | FUJIFILM Wako Pure Chemical Corporation |
| b11 | Para-chlorphenol | 0.25 | FUJIFILM Wako Pure Chemical Corporation |
| b12 | Pyrithione zinc | 0.1 | Tokyo Chemical Industry Co., Ltd. |
| b13 | Piroctone olamine | 0.05 | Tokyo Chemical Industry Co., Ltd. |
| b14 | Phenylbenzimidazole sulfonic acid | 3 | Tokyo Chemical Industry Co., Ltd. |
| b15 | Phenol | 0.1 | Tokyo Chemical Industry Co., Ltd. |
| b16 | Ferulic acid | 10 | Tokyo Chemical Industry Co., Ltd. |
| b17 | Resorcin | 0.1 | FUJIFILM Wako Pure Chemical Corporation |
| b18 | Cetylpyridinium chloride | 5 | Tokyo Chemical Industry Co., Ltd. |
| b19 | Benzalkonium chloride | — | Tokyo Chemical Industry Co., Ltd. |
| b20 | Benzethonium chloride | 0.05 | Tokyo Chemical Industry Co., Ltd. |

### (Evaluation of Ink)

The dispersion stability and dryness prevention effect of the inks according to Examples were evaluated.

### Method of Evaluating Dispersion Stability

The ink was placed in a sealed container after being filtered as described above in the preparation of the ink, left in an environment at 30° C. for 7 days, and filtered again using a syringe filter having a pore size of 5 μm, and the presence or absence of the filtration residue was checked. The dispersion stability of each ink was evaluated on the basis of the following criteria A and B. Inks with the evaluation for the dispersion stability of A are evaluated to “Pass”, and inks with the evaluation of B are evaluated to “Fail”.
A (Good): Without filtration residue
B (Poor): With filtration residue.

### Method of Evaluating Dryness Prevention Effect

The dryness prevention effect was evaluated for only the inks evaluated to “Pass” for the dispersion stability. The dryness prevention effect was evaluated using a modified machine of “TASKalfa Pro 15000c” manufactured by KYOCERA Document Solutions Inc. The recording head was filled with the ink, and then, the ink was left to stand in an environment with a temperature of 25° C. and a humidity of 40% for 5 minutes. After that, a pattern image for checking clogging of the recording head was recorded on the recording medium. Then, the number (N0) of non-ejection nozzles of the recording head before the cleaning operation and the number (N1) of non-ejection nozzles of the recording head after one cleaning operation were measured. The dryness prevention effect of each ink was evaluated in accordance with the following criteria A, B, and C. Inks with the evaluation for the dryness prevention effect of A are evaluated to “Pass”, and inks with the evaluation of B or C are evaluated to “Fail”.
A (Good): both NO and N1 are 10 or less
B (Slightly poor): NO exceeds 10 and N1 is 10 or less
C (Poor): both NO and N1 exceed 10

### (Samples 1 to 26)

Samples 1 to 26 of inks were prepared by the above method. In all of the samples 1 to 26, lithium chloride (LiCl) that is a moisture absorbent was used as the anti-drying agent c. In the samples 1 to 26, the type and content of the preservative b were varied. Table 4 shows the type and content of the preservative b and the evaluation result of the dispersion stability for the samples 1 to 26.

TABLE 4

Evaluation result

| | |
|---|---|
| Preservative | Dryness |

| | | Content | Dispersion | prevention |
|---|---|---|---|---|
| No. | Type | (mass %) | stability | effect |
| 1 | b1 | 7 | B | — |
| 2 | b2 | 7 | B | — |
| 3 | b2 | 4 | B | — |
| 4 | b2 | 1 | B | — |
| 5 | b3 | 1 | B | — |
| 6 | b4 | 1 | B | — |
| 7 | b5 | 10 | B | — |
| 8 | b6 | 1 | B | — |
| 9 | b7 | 0.05 | B | — |
| 10 | b8 | 0.1 | B | — |
| 11 | b9 | 4 | B | — |
| 12 | b10 | 1 | B | — |
| 13 | b11 | 0.25 | B | — |
| 14 | b12 | 0.1 | B | — |
| 15 | b13 | 0.05 | B | — |
| 16 | b14 | 3 | B | — |
| 17 | b15 | 0.1 | B | — |
| 18 | b16 | 10 | B | — |
| 19 | b16 | 7 | B | — |
| 20 | b16 | 1 | B | — |
| 21 | b17 | 0.1 | B | — |
| 22 | b18 | 5 | B | — |
| 23 | b19 | 15 | B | — |
| 24 | b19 | 10 | B | — |
| 25 | b19 | 5 | B | — |
| 26 | b20 | 0.05 | B | — |

All of the samples 1 to 26 were evaluated to “Fail” for the dispersion stability. This is presumably because in all of the samples 1 to 26 in which an ionic moisture absorbent was used as the anti-drying agent c, the presence of ions constituting the moisture absorbent in addition to ions constituting the preservative b caused the agglomeration of the pigment a.

### (Samples 27 to 52)

Samples 27 to 52 of inks were prepared by the above method. In all of the samples 27 to 52, glycerin that is a moisturizing agent was used as the anti-drying agent c. In the samples 27 to 52, the type and content of the preservative b were varied. Table 5 shows the type and content of the preservative b and the evaluation results of dispersion stability and dryness prevention effect for the samples 27 to 52.

TABLE 5

Evaluation result

| | |
|---|---|
| Preservative | Dryness |

| | | Content | Dispersion | prevention |
|---|---|---|---|---|
| No. | Type | (mass %) | stability | effect |
| 27 | b1 | 7 | B | — |
| 28 | b2 | 7 | B | — |
| 29 | b2 | 4 | B | — |
| 30 | b2 | 1 | A | B |
| 31 | b3 | 1 | A | B |
| 32 | b4 | 1 | A | B |
| 33 | b5 | 10 | B | |
| 34 | b6 | 1 | A | B |
| 35 | b7 | 0.05 | A | B |
| 36 | b8 | 0.1 | A | B |
| 37 | b9 | 4 | B | — |
| 38 | b10 | 1 | A | B |
| 39 | b11 | 0.25 | A | B |
| 40 | b12 | 0.1 | A | B |
| 41 | b13 | 0.05 | A | B |
| 42 | b14 | 3 | A | B |
| 43 | b15 | 0.1 | A | B |
| 44 | b16 | 10 | B | — |
| 45 | b16 | 7 | B | — |
| 46 | b16 | 1 | A | B |
| 47 | b17 | 0.1 | A | B |
| 48 | b18 | 5 | A | B |
| 49 | b19 | 15 | B | — |
| 50 | b19 | 10 | B | — |
| 51 | b19 | 5 | A | B |
| 52 | b20 | 0.05 | A | B |

All of the samples 27 to 29, 33, 37, 44, 45, 49, and 50 were evaluated to “Fail” for the dispersion stability. Further, other samples evaluated to “Pass” for the dispersion stability were also evaluated to “Fail” for the dryness prevention effect. This is presumably because in all of the samples 27 to 52 in which glycerin was used as the anti-drying agent c, the effect of preventing drying by the anti-drying agent c was insufficient and the agglomeration of the pigment a could not be suppressed due to ions constituting the preservative b.

### (Samples 53 to 78)

Samples 53 to 78 of inks were prepared by the above method. In all of the samples 53 to 78, DL-carnitine that is a moisturizing agent was used as the anti-drying agent c. In the samples 53 to 78, the type and content of the preservative b were varied. Table 6 shows the type and content of the preservative b and the evaluation result of the dispersion stability for the samples 53 to 78.

TABLE 6

Evaluation result

| | |
|---|---|
| Preservative | Dryness |

| | | Content | Dispersion | prevention |
|---|---|---|---|---|
| No. | Type | (mass %) | stability | effect |
| 53 | b1 | 7 | B | — |
| 54 | b2 | 7 | B | — |
| 55 | b2 | 4 | B | — |
| 56 | b2 | 1 | B | — |
| 57 | b3 | 1 | B | — |
| 58 | b4 | 1 | B | — |
| 59 | b5 | 10 | B | — |
| 60 | b6 | 1 | B | — |
| 61 | b7 | 0.05 | B | — |
| 62 | b8 | 0.1 | B | — |
| 63 | b9 | 4 | B | — |
| 64 | b10 | 1 | B | — |
| 65 | b11 | 0.25 | B | — |
| 66 | b12 | 0.1 | B | — |
| 67 | b13 | 0.05 | B | — |
| 68 | b14 | 3 | B | — |
| 69 | b15 | 0.1 | B | — |
| 70 | b16 | 10 | B | — |
| 71 | b16 | 7 | B | — |
| 72 | b16 | 1 | B | — |
| 73 | b17 | 0.1 | B | — |
| 74 | b18 | 5 | B | — |
| 75 | b19 | 15 | B | — |
| 76 | b19 | 10 | B | — |
| 77 | b19 | 5 | B | — |
| 78 | b20 | 0.05 | B | — |

All of the samples 53 to 78 were evaluated to “Fail” for the dispersion stability. This is presumably because in all of the samples 53 to 78 in which DL-carnitine was used as the anti-drying agent c, the effect of preventing drying by the anti-drying agent c was insufficient and the agglomeration of the pigment a could not be suppressed due to ions constituting the preservative b.

### (Samples 79 to 104)

Samples 79 to 104 of inks were prepared by the above method. In all of the samples 79 to 104, a betaine that is a zwitterionic compound was used as the anti-drying agent c. In the samples 79 to 104, the type and content of the preservative b were varied. Table 7 shows the type and content of the preservative b and the evaluation result of the dispersion stability for the samples 79 to 104.

TABLE 7

Evaluation result

| | |
|---|---|
| Preservative | Dryness |

| | | Content | Dispersion | prevention |
|---|---|---|---|---|
| No. | Type | (mass %) | stability | effect |
| 79 | b1 | 7 | A | A |
| 80 | b2 | 7 | B | — |
| 81 | b2 | 4 | A | A |
| 82 | b2 | 1 | A | A |
| 83 | b3 | 1 | A | A |
| 84 | b4 | 1 | A | A |
| 85 | b5 | 10 | A | A |
| 86 | b6 | 1 | A | A |
| 87 | b7 | 0.05 | A | A |
| 88 | b8 | 0.1 | A | A |
| 89 | b9 | 4 | A | A |
| 90 | b10 | 1 | A | A |
| 91 | b11 | 0.25 | A | A |
| 92 | b12 | 0.1 | A | A |
| 93 | b13 | 0.05 | A | A |
| 94 | b14 | 3 | A | A |
| 95 | b15 | 0.1 | A | A |
| 96 | b16 | 10 | B | — |
| 97 | b16 | 7 | A | A |
| 98 | b16 | 1 | A | A |
| 99 | b17 | 0.1 | A | A |
| 100 | b18 | 5 | A | A |
| 101 | b19 | 15 | A | A |
| 102 | b19 | 10 | A | A |
| 103 | b19 | 5 | A | A |
| 104 | b20 | 0.05 | A | A |

All of the samples 79, 81 to 95, and 97 to 104 according to Examples were evaluated to “Pass” for both the dispersion stability and the dryness prevention effect. On the other hand, the samples 80 and 96 were evaluated to “Fail” for the dispersion stability. This is presumably because orthophenylphenol was excessive in the sample 80 and ferulic acid was excessive in the sample 96.

### (Samples 105 to 130)

Samples 105 to 130 of inks were prepared by the above method. In all of the samples 105 to 130, 3-(1-pyridinio) propanesulfonate that is a sulfobetaine-type zwitterionic compound was used as the anti-drying agent c. In the samples 105 to 130, the type and content of the preservative b were varied. Table 8 shows the type and content of the preservative b and the evaluation result of the dispersion stability for the samples 105 to 130.

TABLE 8

Evaluation result

| | |
|---|---|
| Preservative | Dryness |

| | | Content | Dispersion | prevention |
|---|---|---|---|---|
| No. | Type | (mass %) | stability | effect |
| 105 | b1 | 7 | A | A |
| 106 | b2 | 7 | B | — |
| 107 | b2 | 4 | A | A |
| 108 | b2 | 1 | A | A |
| 109 | b3 | 1 | A | A |
| 110 | b4 | 1 | A | A |
| 111 | b5 | 10 | A | A |
| 112 | b6 | 1 | A | A |
| 113 | b7 | 0.05 | A | A |
| 114 | b8 | 0.1 | A | A |
| 115 | b9 | 4 | A | A |
| 116 | b10 | 1 | A | A |
| 117 | b11 | 0.25 | A | A |
| 118 | b12 | 0.1 | A | A |
| 119 | b13 | 0.05 | A | A |
| 120 | b14 | 3 | A | A |
| 121 | b15 | 0.1 | A | A |
| 122 | b16 | 10 | B | — |
| 123 | b16 | 7 | A | A |
| 124 | b16 | 1 | A | A |
| 125 | b17 | 0.1 | A | A |
| 126 | b18 | 5 | A | A |
| 127 | b19 | 15 | A | A |
| 128 | b19 | 10 | A | A |
| 129 | b19 | 5 | A | A |
| 130 | b20 | 0.05 | A | A |

All of the samples 105, 107 to 121, and 123 to 130 according to Examples were evaluated to “Pass” for both the dispersion stability and the dryness prevention effect. On the other hand, the samples 106 and 122 were evaluated to “Fail” for the dispersion stability. This is presumably because orthophenylphenol was excessive in the sample 106 and ferulic acid was excessive in the sample 122.

### (Samples 131 to 156)

Samples 131 to 156 of inks were prepared by the above method. In all of the samples 131 to 156, trimethylamine N-oxide that is an N,N,N-trialkyl N-oxy compound was used as the anti-drying agent c. In the samples 131 to 156, the type and content of the preservative b were varied. Table 9 shows the type and content of the preservative b and the evaluation result of the dispersion stability for the samples 131 to 156.

TABLE 9

Evaluation result

| | |
|---|---|
| Preservative | Dryness |

| | | Content | Dispersion | prevention |
|---|---|---|---|---|
| No. | Type | (mass %) | stability | effect |
| 131 | b1 | 7 | A | A |
| 132 | b2 | 7 | B | — |
| 133 | b2 | 4 | A | A |
| 134 | b2 | 1 | A | A |
| 135 | b3 | 1 | A | A |
| 136 | b4 | 1 | A | A |
| 137 | b5 | 10 | A | A |
| 138 | b6 | 1 | A | A |
| 139 | b7 | 0.05 | A | A |
| 140 | b8 | 0.1 | A | A |
| 141 | b9 | 4 | A | A |
| 142 | b10 | 1 | A | A |
| 143 | b11 | 0.25 | A | A |
| 144 | b12 | 0.1 | A | A |
| 145 | b13 | 0.05 | A | A |
| 146 | b14 | 3 | A | A |
| 147 | b15 | 0.1 | A | A |
| 148 | b16 | 10 | B | — |
| 149 | b16 | 7 | A | A |
| 150 | b16 | 1 | A | A |
| 151 | b17 | 0.1 | A | A |
| 152 | b18 | 5 | A | A |
| 153 | b19 | 15 | A | A |
| 154 | b19 | 10 | A | A |
| 155 | b19 | 5 | A | A |
| 156 | b20 | 0.05 | A | A |

All of the samples 131, 133 to 147, and 149 to 156 according to Examples were evaluated to “Pass” for both the dispersion stability and the dryness prevention effect. On the other hand, the samples 132 and 148 were evaluated to “Fail” for the dispersion stability. This is presumably because orthophenylphenol was excessive in the sample 132 and ferulic acid was excessive in the sample 148.

What is claimed is:

1. An inkjet ink, comprising:
a pigment;
a zwitterionic compound that has a zwitterionic structure in an environment with a pH of 7.5 or more and 9 or less;
at least one preservative selected from the group consisting of 2-(2-hydroxy-5-methylphenyl)benzotriazole, orthophenylphenol, chlorcresol, sodium salicylate, sodium dihydroxydimethoxybenzophenonedisulfonate, sodium sorbate, thymol, trichlorohydroxydiphenyl ether, para-aminobenzoic acid, methyl para-hydroxybenzoate, para-chlorphenol, pyrithione zinc, piroctone olamine, phenylbenzimidazole sulfonic acid, phenol, ferulic acid, resorcin, cetylpyridinium chloride, benzalkonium chloride, and benzethonium chloride; and
water,
a content of orthophenylphenol being 4 mass % or less, and
a content of ferulic acid being 7 mass % or less.

2. The inkjet ink according to claim 1, wherein
the zwitterionic compound is at least one selected from the group consisting of a betaine-type compound, a sulfobetaine-type compound, and an N,N,N-trialkyl N-oxy compound, and does not include any of a linear alkane skeleton having four or more carbon atoms, a triethylene glycol skeleton having four or more carbon atoms, or a tripropylene glycol skeleton having four or more carbon atoms.

3. The inkjet ink according to claim 1, wherein
the preservative includes at least one selected from the group consisting of 2-(2-hydroxy-5-methylphenyl)benzotriazole, orthophenylphenol, sodium dihydroxydimethoxybenzophenonedisulfonate, para-aminobenzoic acid, ferulic acid, and benzalkonium chloride.
